(19) United States
(12) Patent Application Publication
(10) Pub. No.: US 2026/0196427 A1
(43) Pub. Date: Jul. 9, 2026

(54) ELECTRICAL CONTACTOR WITH RECIRCULATION OF IONIZED GASES

(71) Applicant: SAFRAN ELECTRICAL & POWER, BLAGNAC (FR)

(72) Inventors: Guillaume PRIEUR, MOISSY CRAMAYEL (FR); Arnaud BADAULT, MOISSY CRAMAYEL (FR); Kévin ENOUF, MOISSY CRAMAYEL (FR)

(21) Appl. No.: 19/127,829

(22) PCT Filed: Nov. 6, 2023
(86) PCT No.: PCT/FR2023/051734

§ 371 Date: May 7, 2025

(30) Foreign Application Priority Data
Nov. 8, 2022 (FR) FR2211610

(51) Int. Cl. H01H 33/06; H01H 33/38

(52) U.S. Cl. CPC H01H 33/06; H01H 33/38

(57) ABSTRACT

A contactor includes one or two electric arc extinguishing zones each including a magnetic blowout device which moves the electric arc—arising between a fixed contact and a movable contact of a movable bridge switching to the open state—toward an electric arc extinguishing block including a plurality of stacked parallel fins. Each extinguishing zone is bounded in particular by two side walls each located at a distance from the fins of an electric arc extinguishing block, an upper wall and a lower wall which is located at a distance from the fins of the electric arc extinguishing blocks and is connected to each side wall by a concave connection of curved cross-section. The fins of each electric arc extinguishing block are inclined by an angle a of between 30 and 85 degrees with respect to the inner surface of the closest side wall.

### TECHNICAL FIELD OF THE INVENTION

The technical field of the invention is that of high-voltage direct current contactors, and more particularly that of high-voltage direct current contactors including electric arc extinction fin blocks for sectioning the electric arc into several arcs.

The present invention relates to a double-break high-voltage direct current contactor including electric arc extinction fin blocks for extinguishing two electric arcs simultaneously and wherein ionised gases at the electric arcs are generated during the break. The present invention more particularly relates to an electric arc extinction zone of such a contactor in which means are provided for circulating ionised gases.

### TECHNOLOGICAL BACKGROUND OF THE INVENTION

High-Voltage Direct Current (HVDC) is a power electronics technology used for the transmission of high-voltage direct current electricity.

High-voltage direct current (HVDC) contactors include two electrical contacts for making, supporting and interrupting an electrically conductive connection for currents in continuous rating with a voltage usually in the order of 270 to 3000 volts in the field of aeronautics or automobile. Upon separation of contacts, electric arcs appear, accompanied with high thermal stresses as well as difficulties in extinguishing the electrical connection. These problems are even more critical when the electrical voltage is high. It is therefore necessary to extinguish these electric arcs quickly.

Usually, in today's contactors, extinction of an electric arc is performed by moving each electric arc by a magnetic field in the direction of an arc extinction zone comprising electric arc extinction fin blocks. This movement of each electric arc is achieved by virtue of the electromagnetic Laplace force. Each electric arc extinction block includes a plurality of fins being stacked and distant from each other in order to section the electric arc into several arcs each circulating in a different fin of a same electric arc extinction block. Sectioning the arc makes it possible to increase the arc voltage and thus extinguish it.

Each electric arc ionises air present in the arc extinction zone and also ionises particles of inner components of the contactor which are torn off on contact with the electric arc, thereby generating gases referred to as quenching gases. These ionised quenching gases have an extremely high temperature and are therefore dangerous to the inner components of the contactor. In addition, after passing through the fins of an electric arc extinction block, the quenching gases hit the wall behind said extinction block and tend to flow back in the direction of the electric arc. This backflow of quenching gases hitting the outer walls of the extinction zone then tends to oppose the Laplace force which tends to move the electric arc in the direction of the fins. The force of this backflow being proportional to the power of the arc, in the case of a high-power electric arc, the force of this backflow of the quenching gases is likely to prevent such an electric arc from coming into contact with the extinction block.

The electric arc is then not divided and the electrical connection is not extinguished. Furthermore, due to the pressure and temperature conditions in the extinction zone resulting from the formation of the quenching gas, the presence of quenching gas in the extinction zone tends to limit the maximum cut-off current, especially to a value of less than 1000 A.

This phenomenon is illustrated in FIG. 4 which illustrates a first example of a contactor 1′ of prior art at an extinction zone 5a′ provided in a contactor chamber 23′ and especially delimited by two side walls 12a′, 12b′ facing each other, by an upper wall 13′ and by a lower wall 14′ facing the upper wall 13′ and at a distance from the fins 10 of the electric arc extinction blocks 9a′, 9b′. The two side walls 12a′, 12b′ are each located in the immediate proximity of an electric arc extinction block 9a′, 9b′ and each have an inner surface 20a′, 20b′. In this contactor 1′, each electric arc extinction block 9a′, 9b′ includes a plurality of fins 10′ being stacked and distant from each other. Within a same electric arc extinction block 9a′, 9b′, the fins 10′ are parallel and each extend along a longitudinal axis X′ which is orthogonal to the side walls 12a′, 12b′ and which is parallel to the direction of the Laplace force 18a′ generated by a magnetic force 7′ coming from a magnet or a coil. When an electric arc 8a′ appears between a fixed contact 4a′ of a fixed terminal 24a′ and a movable contact 3a′ of a movable bridge 2′ shifting to the open state, the Laplace force 18a′ moves this electric arc 8a′ in the direction of an electric arc extinction block 9a′, 9b′. In FIG. 4, it is clearly seen that the ionised quenching gases 22′ generated by the electric arc 8a′ are directed towards the side wall 12b′, hit the inner surface 20b′ thereof, and then flow back in the direction of the contacts 4a′, 3a′ between which the electric arc 8a′ has appeared. These ionised quenching gases 22′ thus tend to oppose the movement of the electric arc 8a′ in the direction of the electric arc extinction block 9a′ and are likely to deteriorate elements present within the extinction zone 5a′.

There is therefore a need to circulate ionised gases.

As is represented in FIG. 5, a solution contemplated in prior art consists in providing a second example of contactor 1″, very similar to the first example of contactor 1′ of prior art, but having side openings in each extinction zone 5a′ facing and in proximity to the electric arc extinction blocks 9a′, 9b′, so as to allow the ionised quenching gases 22′ to be expelled out of the contactor chamber 23′. In the prior solution represented in FIG. 5, the side openings are made by simply removing the usual side walls 12a′, 12b′. More elaborate solutions can be contemplated to create these side openings. Nevertheless, it can be noticed that spraying of ionised quenching gases 22′ out of the contactor chamber 23′ is however dangerous to the equipment next to the contactor 1″. With this solution, it is therefore necessary to provide an exclusion zone which prohibits the placement of other equipment next to the contactor 1″. This exclusion zone, which can be in the order of several centimetres, restricts the integration of the contactor 1″, and is particularly disadvantageous in some fields, especially aeronautics, where a high volume represents a critical restriction.

In the field of air-break multipole electrical circuit breakers, in which similar problems of ionised quenching gases can occur at high currents, another solution disclosed by documents EP 3 179 497 A1 and EP 0 437 151 A1 consists in equipping said circuit breakers with a device for cooling and de-ionising the ionised quenching gases before they are discharged outside the circuit breakers. The equipment installed next to the circuit breakers is then protected from the ionised quenching gases, but the device used to cool and de-ionise the quenching gases considerably increases the cost, volume and mass of the circuit breakers, which is restrictive, and even more so in the field of aeronautics where equipment with minimal volume and mass is desired.

The current solutions are therefore unsatisfactory.

### SUMMARY OF THE INVENTION

The invention provides a solution to the problems discussed previously, by allowing ionised gases to circulate in an extinction zone without the need to provide side openings for the expulsion of ionised quenching gases, or a device for cooling and de-ionising the quenching gases before they are discharged to the outside.

Whereas prior solutions encourage the person skilled in the art to expel the ionised quenching gases to outside of the contactor so that their flow does not oppose the electromagnetic force aiming at directing the electric arc in the direction of the fins of the electric arc extinction blocks, the solution of the invention consists, on the contrary, in diverting these quenching gases towards inside of the contactor, but so that their flow does not flow back after hitting the side walls of the electric arc extinction zones.

An additional effect is achieved by virtue of the invention by the quenching gas flow being able to be diverted towards the arc in a return loop path, in order to pass through the electric arc in the direction of the electric arc extinction blocks, so as to additionally accelerate the electric arc in the direction of the electric arc sectioning fins, thereby enhancing the Laplace force already fulfilling this role and enhancing the safety role of the electric arc extinction device.

One aspect of the invention relates to a double-break contactor comprising:
a contactor chamber comprising:
   a bridge being movable between a closed state and an open state, comprising a first movable contact and a second movable contact,
   a first fixed contact facing the first movable contact, and
   a second fixed contact facing the second movable contact,
   at least one electric arc extinction zone, each comprising two electric arc extinction blocks facing each other on either side of the movable bridge and each including a plurality of fins each extending along a longitudinal axis,
wherein:
the contactor chamber is closed;
each electric arc extinction zone is especially delimited by:
   two side walls facing each other, each located on the side of an electric arc extinction block and at a distance from the fins thereof, each having an inner surface,
   an upper wall located on the side of a fixed contact, and
   a lower wall facing the upper wall, at a distance from the fins of the electric arc extinction blocks and connected to each side wall by a link having a concave inner surface with a curved cross-section; and
the fins of each electric arc extinction block are tilted so that their longitudinal axis forms an angle a of between 30 degrees and 85 degrees relative to the inner surface of the closest side wall.

The fins are away from the side walls and the lower wall at least by a distance of between 3 mm to 20 mm.

The angle α is oriented so that the edge of the fins closest to a side wall is closer to the lower wall than to the upper wall.

By virtue of the tilt of the fins relative to the inner surface of the closest side wall, after hitting said wall, the ionised quenching gases are directed towards the lower wall. Since the side walls are located at a distance from the fins of the closest electric arc extinction block, there is a free volume located between these walls and the fins of the extinction blocks, which advantageously allows the flow of ionised quenching gases to circulate freely towards the lower wall, without flowing back. When it arrives in the immediate proximity of the lower wall, this flow is diverted by a concave inner surface with a curved cross-section in the direction of the opposite side wall to flow back towards the median part of the electric arc extinction zone. During this path, the ionised quenching gases have time to cool and deionise, and therefore no longer represent a danger to the components located at the heart of the extinction zone. The tilt of the fins reduces the volume they occupy in the direction of the side walls, which substantially compensates for the additional volume required between the side walls and the extinction blocks, this volume being greatly exaggerated in FIGS. 6 to 8 for the sake of clarity.

Thus, by the new circulation path that it imposes on the flow of ionised quenching gases, the contactor according to the invention advantageously makes it possible to neutralise the danger represented by the ionised quenching gases, without having to significantly increase the volume or mass of said contactor, nor having to provide an exclusion zone which prohibits placement of other equipment next to the contactor.

According to one aspect of the invention, the angle a is between 60 degrees and 80 degrees.

According to another aspect of the invention, the contactor comprises at least one magnetic field emitter device having constant direction, generating a magnetic force which exerts an electromagnetic Laplace force capable of moving-in the direction of an electric arc extinction block-an electric arc appearing between a fixed contact and a movable contact of the movable bridge shifting from the closed state to the open state, and the side walls extend in a plane orthogonal to the orientation of the electromagnetic Laplace force generated by the magnetic field emitter device.

According to a further aspect of the invention, the electric arc extinction blocks are parallel to each other.

According to one aspect of the invention, the side walls and the electric arc extinction blocks are parallel.

According to another aspect of the invention, each link having a concave inner surface with a curved cross-section has a radius of curvature R1 of between 3 mm and 20 mm.

The geometric distinctive features previously described advantageously enable circulation of the flow of ionised quenching gases along the path desired for the invention, while minimising mass and volume of the contactor.

According to a further aspect of the invention, each electric arc extinction zone comprises two parallel deflectors which each extend inside the electric arc extinction zone from the lower wall and in the direction of the movable bridge, each deflector being connected to the lower wall, on the side of the closest electric arc extinction block, by another link having a concave inner surface with a curved cross-section.

According to one aspect of the invention, each electric arc extinction zone comprises a single deflector which extends inside the electric arc extinction zone from the lower wall and in the direction of the movable bridge, the single deflector being connected to the lower wall by two other mirror-arranged links and having a concave inner surface with a curved cross-section.

According to another aspect of the invention, each of the other links having a concave inner surface with a curved cross-section has a radius of curvature R2 of between 3 mm and 20 mm.

Advantageously, these deflectors and their geometry enable the flow of quenching gases to be redirected along a loop path so that it passes through the electric arc in the direction of the electric arc extinction blocks. Thus, the flow of quenching gases is added to the Laplace force to ensure that the electric arc is duly moved in the direction of the electric arc sectioning fins.

According to a further aspect of the invention, the deflectors and the electric arc extinction blocks are parallel, which additionally encourages the flow of quenching gases to follow the loop path previously described.
Further to the characteristics just discussed in the preceding paragraph, the contactor according to one aspect of the invention may have one or more complementary characteristics from among the following, considered individually or according to any technically possible combinations:
In the closed state of the movable bridge, the first and second movable contacts are in contact with the first and second fixed contacts respectively, and in the open state of the movable bridge, the first and second movable contacts are distant from the first and second fixed contacts respectively,
Within a same electric arc extinction block, the fins are stacked, distant from each other and parallel.
Each electric arc extinction zone comprises two arc guides facing each other and each located between an electric arc extinction block and a movable contact.
The distance between the inner surface of a side wall and the fins of the closest electric arc extinction block is between 3 mm and 20 mm.
When each electric arc extinction zone comprises a single deflector, the latter is located halfway between each of the electric arc extinction blocks.
The lower wall has an inner face, and each deflector extends perpendicularly to this inner face.

The invention and its different applications will be better understood upon reading the following description and upon examining the accompanying figures.

### BRIEF DESCRIPTION OF THE FIGURES

The figures are set forth by way of indicating and in no way limiting purposes of the invention.

FIG. 1 is a schematic overall planar view of a contactor comprising two electric arc extinction zones, each comprising two electric arc extinction blocks.

FIG. 2 is a schematic overall planar view of a contactor comprising a single electric arc extinction zone comprising two electric arc extinction blocks.

FIG. 3 is a schematic cross-section view of a contactor along the axis III-III of FIG. 1.

FIG. 4 is a cross-section view along the axis IV-IV of FIG. 1 of a contactor of prior art in which the ionised quenching gases tend to flow back to oppose the Laplace force which directs the electric arc in the direction of the fins.

FIG. 5 is a cross-section view along the axis IV-IV of FIG. 1 of a contactor of prior art in which the ionised quenching gases are expelled out of the contactor chamber.

FIG. 6 is a cross-section view along the axis IV-IV of FIG. 1 of a contactor of the invention not including a deflector.

FIG. 7 is a cross-section view along the axis IV-IV of FIG. 1 of a contactor of the invention in which each electric arc extinction zone comprises two deflectors back to back.

FIG. 8 is a cross-section view along the axis IV-IV of FIG. 1 of a contactor of the invention in which each electric arc extinction zone comprises a single deflector.

### DETAILED DESCRIPTION

The figures are set forth by way of indicating and in no way limiting purposes of the invention.

The terms “front”, “rear”, “upper” and “lower” used in this description are terms chosen arbitrarily for the purpose of simplifying drafting and do not necessarily correspond to reality, but rather to the position of the contactors represented in the figures, it being understood that, in use, the contactor 1 of the invention can assume any orientation and position.

The double-break contactor 1 of the invention is preferably a high-voltage direct current (HVDC) contactor. However, the principle of the invention can be adapted to any type of contactor, including all switches and circuit breakers in which electric arcs are likely to be generated.

Conventionally, the contactor 1 of the invention comprises a movable bridge 2 including a first movable contact 3a and a second movable contact 3b, a first fixed terminal 24a including a first fixed contact 4a and a second fixed terminal 24b including a second fixed contact 4b. The first movable contact 3a faces the first fixed contact 4a and the second movable contact 3b faces the second fixed contact 4b. Depending on how the contactor 1 is electrically connected, one of the fixed terminals 24a, 24b is a positive pole terminal while the other is a negative pole terminal. In the figures, the first fixed terminal 24a is a positive pole terminal while the second fixed terminal 24b is a negative pole terminal.

When the movable bridge 2 is in the closed state, a current/flows from the first fixed contact 4a to the second fixed contact 4b by passing through the movable bridge 2. Of course, the electrical circulation of the current/can be reversed so that the current/flows from the second fixed contact 4b towards the first fixed contact 4a by passing through the movable bridge 2.

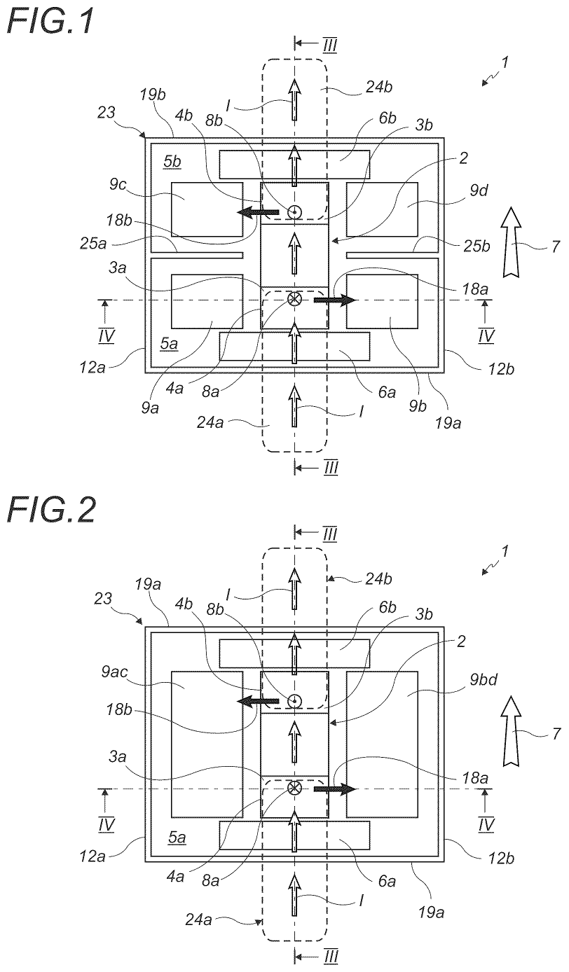

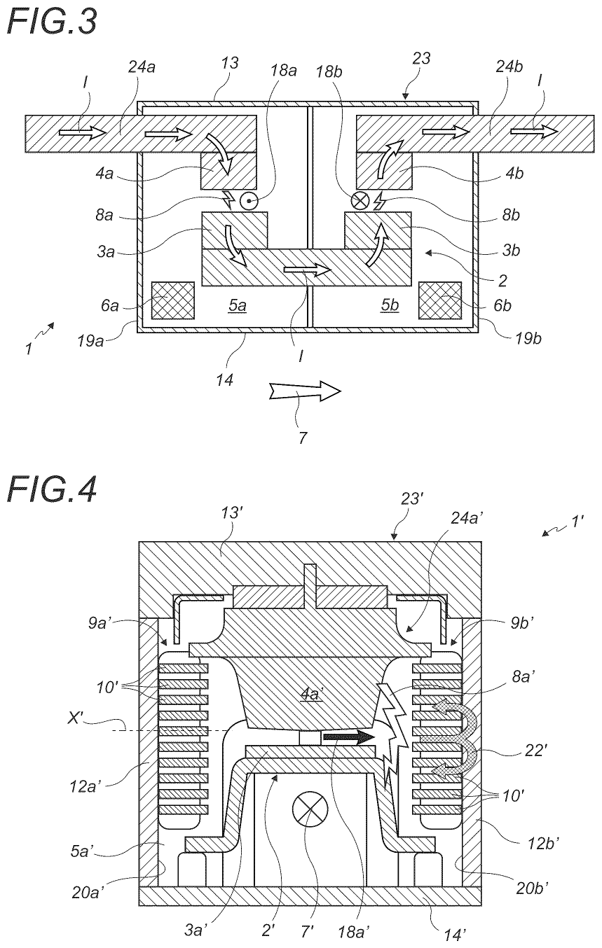

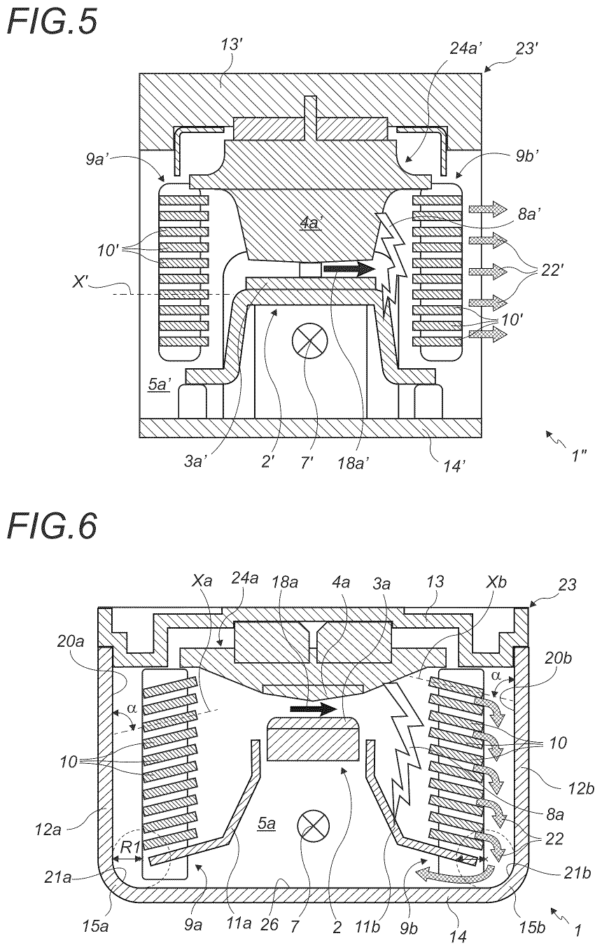

FIGS. 1 to 3 represent the movable bridge 2 in the open state. In these figures, the circulation of current/is symbolised by a succession of white arrows. Upon opening the movable bridge 2, the movable contacts 3a, 3b are moved away from the fixed contacts 4a, 4b, and a first electric arc 8a is likely to appear between the first movable contact 3a and the first fixed contact 4a, while a second electric arc 8b is likely to appear between the first movable contact 3b and the first fixed contact 4b.

In order to quickly extinguish these electric arcs 8a, 8b, conventionally, the contactor 1 of the invention comprises an arc-blast device to divert each electric arc 8a, 8b towards an electric arc extinction block 9a, 9b, 9c, 9d. This arc-blast device is housed in a contactor chamber 23 forming a closed enclosure. The fixed contacts 4a, 4b and the movable contacts 3a, 3b are also located in the contactor chamber 23.

The contactor chamber 23 is delimited by:
two side walls 12a, 12b facing each other and each having an inner surface 20a, 20b,
an upper wall 13 located on the side of the fixed contacts 4a, 4b,
a lower wall 14 located on the side of the movable contacts 3a, 3b facing the upper wall 13,
a front wall 19a located on the side of the first fixed terminal 24a, and
a rear wall 19b located on the side of the second fixed terminal 24b facing the front wall 19a.

The arc-blast device comprises at least one magnetic field emitter device 6a, 6b having constant direction, generating a magnetic force 7. This magnetic field emitter device 6a, 6b may for example comprise one or more magnets and/or one or more coils. The magnetic force 7 generated by the magnetic field emitter device 6a, 6b exerts an electromagnetic Laplace force 18a, 18b on each electric arc 8a, 8b so as to move it in the direction of the closest electric arc extinction block 9a, 9b, 9c, 9d. These movements can be guided by two arc guides 11a, 11b facing each other and each located between an electric arc extinction block 9a, 9b, 9c, 9d and a movable contact 3a, 3b.

The electric arc extinction blocks 9a, 9b, 9c, 9d are provided in pairs and facing each other on either side of the movable bridge 2. Each electric arc extinction block 9a, 9b, 9c, 9d includes a plurality of fins 10 being stacked, parallel and distant from each other, whose role is to divide each electric arc 8a, 8b into several smaller electric arcs, and therefore easier to extinguish. The electric arc extinction blocks 9a, 9b, 9c, 9d are preferably parallel to each other. Within a same electric arc extinction block 9a, 9b, 9c, 9d, the fins 10 each extend along a longitudinal axis Xa, Xb.

The contactor chamber 23 comprises at least one electric arc extinction zone 5a, 5b comprising two electric arc extinction blocks 9a, 9b, 9c, 9d and two arc guides 11a, 11b.

In FIG. 1, a type of contactor 1 including two electric arc extinction zones 5a, 5b, and consequently including four electric arc extinction blocks 9a, 9b, 9c, 9d and four arc guides 11a, 11b is represented. These two electric arc extinction zones 5a, 5b may be separated by a single partition wall or by two partition walls 25a, 25b located between the two pairs of electric arc extinction blocks 9a, 9b, 9c, 9d.

In FIG. 2, a type of contactor 1 including a single electric arc extinction zone 5a, and therefore including two electric arc extinction blocks 9a, 9b and two arc guides 11a, 11b is represented.

In these two alternatives, the arc-blast device and the ionised quenching gas circulation principle according to the invention operate according to one and the same mode.

The contactor 1 of the invention has especially the feature that the contactor chamber 23 is closed, so that the ionised quenching gases 22 generated by each electric arc 8a, 8b cannot leave said contactor chamber 23. Indeed, by closed enclosure, it is meant a closed enclosure especially having no opening through which ionised quenching gases 22 could pass to leave the contactor chamber 23.

The contactor 1 of the invention has also the feature that the two side walls 12a, 12b facing each other are each located at a distance from the closest electric arc extinction block 9a, 9b, 9c, 9d, so that the inner surface 20a, 20b of each side wall 12a, 12b is provided at a distance from the fins 10 of the closest electric arc extinction block 9a, 9b, 9c, 9d. The distance between the inner surface 20a, 20b of a side wall 12a, 12b and the fins 10 of the closest electric arc extinction block 9a, 9b, 9c, 9d is preferably between 3 mm and 20 mm. According to a preferred embodiment of the invention, the side walls 12a, 12b extend in a plane orthogonal to the orientation of the electromagnetic Laplace force 18a, 18b generated by the magnetic field emitter device 6a, 6b. The side walls 12a, 12b and the electric arc extinction blocks 9a, 9b, 9c, 9d are preferably parallel.

Also, the lower wall 14 facing the upper wall 13 is located at a distance of between 3 mm and 20 mm from the fins 10 of the electric arc extinction blocks 9a, 9b, 9c, 9d. The lower wall 14 is connected to each side wall 12a, 12b by a link 15a, 15b having a concave inner surface 21a, 21b with a curved cross-section. Each link 15a, 15b having a concave inner surface 21a, 21b with a curved cross-section preferably has a radius of curvature R1 of between 3 mm and 20 mm.

The contactor 1 of the invention has also the feature that the fins 10 of each electric arc extinction block 9a, 9b, 9c, 9d are tilted so that their longitudinal axis Xa, Xb forms an angle a of between 30 degrees and 85 degrees relative to the inner surface 20a, 20b of the closest side wall 12a, 12b. The angle a is preferably between 60 degrees and 80 degrees.

By virtue of the invention, by passing through tilted fins 10, the flow of ionised quenching gases 22 generated by each electric arc 8a, 8b is obliquely directed in the direction of the side wall 12a, 12b towards which each electric arc 8a, 8b is moved. Thus, the axis of movement of the flow of ionised quenching gases 22 forms an angle of between 30 degrees and 85 degrees relative to the inner surface 20 a, 20 b of the side wall 12a, 12b towards which it is directed, this angle corresponding to the tilt angle a of the fins 10. As the flow of ionised quenching gases 22 does not hit the inner surface 20a, 20b of the side wall 12a, 12b orthogonally, it does not flow back, but is instead diverted in the direction of the lower wall 14, as is apparent in FIGS. 6 to 8. The flow of ionised quenching gas 22 follows a path along a free space firstly provided between the electric arc extinction blocks 9a, 9b, 9c, 9d and the closest side wall 12a, 12b, and then provided between the electric arc extinction blocks 9a, 9b, 9c, 9d and the lower wall 14, to return to the heart of the electric arc extinction zone 5a, 5b, preferably between the electric arc extinction blocks 9a, 9b, 9c, 9d of a same pair.

According to one alternative of the invention, each electric arc extinction zone 5a, 5b may include one or more deflectors 16a, 16b which each extend inside said electric arc extinction zone 5a, 5b from the lower wall 14 and in the direction of the movable bridge 2, preferably perpendicularly to the inner face 26 of said lower wall 14.

Each deflector 16a, 16b is provided to further divert the course of the flow of ionised quenching gases 22 along the lower wall 14 so as to orient it towards the upper wall 13 and towards the electric arc 8a, 8b. Thus, the dynamic force of the flow of ionised quenching gases 22 is added to the electromagnetic Laplace force aiming at moving each arc 8a, 8b in the direction of an electric arc extinction block 9a, 9b, 9c, 9d.

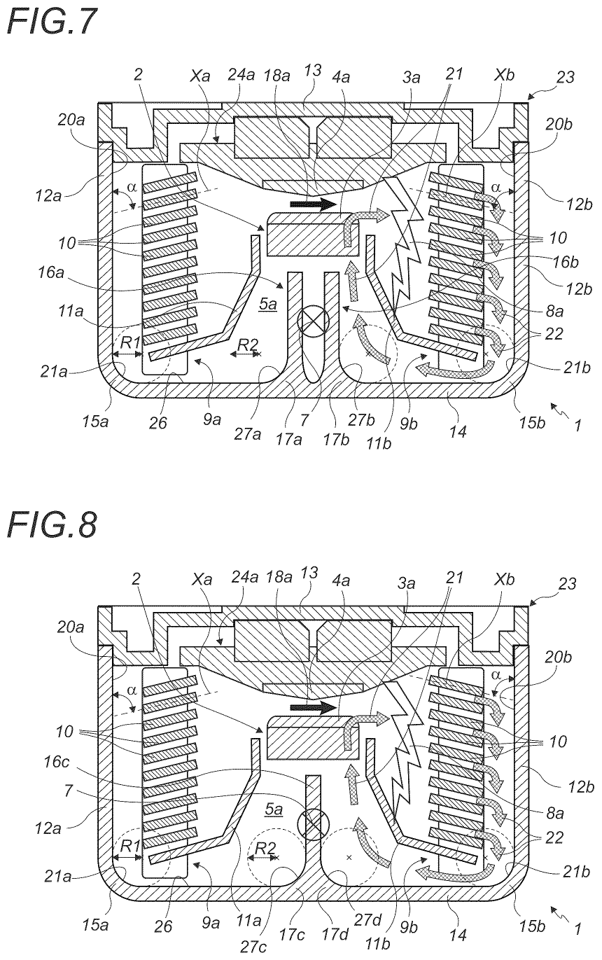

According to one alternative of the invention represented in FIG. 7, each electric arc extinction zone 5a, 5b comprises two parallel deflectors 16a, 16b which each extend inside the electric arc extinction zone 5a, 5b from the lower wall 14 and in the direction of the movable bridge 2. Each deflector 16a, 16b is then connected to the lower wall 14, on the side of the closest electric arc extinction block 9a, 9b, 9c, 9d, by another link 17a, 17b having a concave inner surface 27a, 27b with a curved cross-section. These other concave links 17a, 17b with a curved cross-section each preferably have a radius of curvature R2 of between 3 mm and 20 mm.

According to another alternative of the invention represented in FIG. 8, each electric arc extinction zone 5a, 5b comprises a single deflector 16c which extends inside the electric arc extinction zone 5a, 5b from the lower wall 14 and in the direction of the movable bridge 2. The single deflector 16c is then connected to the lower wall 14 by two other concave mirror-arranged links 17c, 17d and having a concave inner surface 27c, 27d with a curved cross-section, with a radius of curvature R2 preferably of between 3 mm and 20 mm. The single deflector 16c is preferably located halfway between each of the electric arc extinction blocks 9a, 9b, 9c, 9d.

Having a single deflector 16c per electric arc extinction zone 5a, 5b advantageously makes it possible to simplify and lighten the contactor 1, while having two deflectors 16a, 16b makes it possible to easily provide each of these deflectors 16a, 16b at the desired distance from the electric arc extinction blocks 9a, 9b, 9c, 9d.

Unless otherwise specified, a same element appearing in different figures has a single reference.

1. A double-break contactor comprising:
a contactor chamber comprising:
a bridge being movable between a closed state and an open state, comprising a first movable contact and a second movable contact,
a first fixed contact facing the first movable contact, and
a second fixed contact facing the second movable contact,
at least one electric arc extinction zone, each comprising two electric arc extinction blocks facing each other on either side of the movable bridge and each including a plurality of fins each extending along a longitudinal axis (Xa, Xb),
wherein:
the contactor chamber is closed;
each electric arc extinction zone is especially delimited by:
two side walls facing each other each located on the side of an electric arc extinction block and at a distance from the fins thereof, each having an inner surface,
an upper wall located on the side of a fixed contact, and
a lower wall facing the upper wall, at a distance from the fins of the electric arc extinction blocks and connected to each side wall by a link having a concave inner surface with a curved cross-section; wherein
the fins are away from the side walls and the lower wall at least by a distance of between 3 mm and 20 mm, and wherein
the fins of each electric arc extinction block are tilted so that their longitudinal axis (Xa, Xb) forms an angle α of between 30 degrees and 85 degrees relative to the inner surface of the closest side wall, wherein the angle α is oriented such that the edge of the fins closest to a side wall is closer to the lower wall than to the upper wall.

2. The contactor according to claim 1, wherein the angle α is between 60 degrees and 80 degrees.

3. The contactor according to claim 1, further comprising at least one magnetic field emitter device having constant direction, generating a magnetic force which exerts an electromagnetic Laplace force capable of moving in the direction of an electric arc extinction block an electric arc appearing between a fixed contact and a movable contact of the movable bridge shifting from the closed state to the open state, and wherein the two side walls extend in a plane orthogonal to the orientation of the electromagnetic Laplace force generated by the magnetic field emitter device.

4. The contactor according to claim 1, wherein the electric arc extinction blocks are parallel to each other.

5. The contactor according to claim 1, wherein the two side walls and the electric arc extinction blocks are parallel.

6. The contactor according to claim 1, wherein each link having a concave inner surface with a curved cross-section has a radius of curvature R1 of between 3 mm and 20 mm.

7. The contactor according to claim 1, wherein each electric arc extinction zone comprises two parallel deflectors which each extend inside the electric arc extinction zone from the lower wall and in the direction of the movable bridge, each deflector being connected to the lower wall, on the side of the closest electric arc extinction block, by another link having a concave inner surface with a curved cross-section.

8. The contactor according to claim 1, wherein each electric arc extinction zone comprises a single deflector which extends inside the electric arc extinction zone from the lower wall and in the direction of the movable bridge, the single deflector being connected to the lower wall by two other mirror-arranged links and having a concave inner surface with a curved cross-section.

9. The contactor according to claim 7, wherein each of the other links having a concave inner surface with a curved cross-section has a radius of curvature R2 of between 3 mm and 20 mm.

10. The contactor according to claim 7, wherein the deflectors and the electric arc extinction blocks are parallel.
